(19) United States
(12) Patent Application Publication
(10) Pub. No.: US 2013/0099499 A1
(43) Pub. Date: Apr. 25, 2013

(54) SMALL TURBINES IN URBAN SEWAGE AND STORM WATER FLOW SYSTEMS USED IN ONSITE POWER PLANTS FOR HYDROGEN FUEL PRODUCTION AND WATER PURIFICATION

(71) Applicant: Seymour R. Levin, Los Angeles, CA (US)

(72) Inventor: Seymour R. Levin, Los Angeles, CA (US)

(21) Appl. No.: 13/654,333

(22) Filed: Oct. 17, 2012

Related U.S. Application Data
(60) Provisional application No. 61/549,100, filed on Oct. 19, 2011.

(51) Int. Cl. F03B 13/10

(52) U.S. Cl. 290/52

(57) ABSTRACT

Sewage and/or storm water flow systems and methods, which use generator and small turbine assemblies positioned within sewage and/or storm water conduits are disclosed herein. One system configuration includes a generator, at least one electrical connector coupled to the generator, and a small turbine coupled to the generator. The turbine includes a shaft mountable to a lower sewage conduit base and at least one anchor coupled to the shaft, which is mountable to a conduit wall section. The generator and turbine assemblies may also be arranged in a sequential array positioned within one or more modified conduits for generation of on-site electricity, which can be used for various green technologies, including water purification, water desalination, and manufacture of hydrogen fuel.

### CROSS-REFERENCE TO RELATED APPLICATION

This application claims priority under 35 U.S.C. §119(e) to U.S. Application Ser. No. 61/549,100, filed Oct. 19, 2011, the entirety of which is incorporated herein by reference.

### BACKGROUND OF THE INVENTION

1. Field

The present disclosure relates to urban sewage and storm water flow systems, using small turbines in assemblies, arrays, and onsite power plants.

2. Background

Energy, particularly in the United States, is primarily derived from non-renewable energy sources. Oil, coal, and natural gas, for example, are some non-renewable energy sources, which are being depleted to provide communities around the world with electrical power. Although alternatives to non-renewable energy sources exist, they are underutilized. In the United States, for example, less than 10% of the total U.S. electricity production is derived from renewable energy sources. (2009 Annual Energy Review, U.S. Energy Information Admin., August 2010).

Use of some non-renewable energy sources can also cause significant environmental issues. As a result, many countries have increased their efforts to reduce emission of pollutants and consumption of nonrenewable sources. Many countries, therefore, continue to seek renewable and environmentally friendly sources of energy.

Renewable energy sources generally can be classified into two groups: continuous and intermittent sources of energy. Wind and solar energy are primarily intermittent. Thus, power plants, relying on wind and/or solar energy are literally at the mercy of nature. Because these sources are unpredictable, they are frequently used alongside non-renewable energy sources. In some cases, power plants, which primarily use non-renewable sources of energy, are able to reduce or idle their power production through use of wind and solar power. Nonetheless, implementing wind and solar power in this manner is still not cost-effective and over time may increase overall production costs.

In contrast, geothermal and hydrodynamic energy sources can be harnessed for continuous energy production. Geothermal energy, at least in the United States, is currently derived from just few areas. Unfortunately, these sources of geothermal energy merely produce less than one half of one percent of electricity in the United States.

Hydrodynamic energy is available from a significant number of sources—both natural and man-made. Traditionally, large scale reservoirs, which are elevated in excess of 100 feet, are used to generate large quantities of electricity at various locations. Dams and waterfalls may also be used to provide the necessary head to turn water turbines. Unfortunately, large scale reservoirs require significant capital costs and alter ecosystems of surrounding areas.

It would be desirable, therefore, to provide methods and systems for generation and use of energy from alternative sources, that overcome the limitations and disadvantages as summarized above.

### SUMMARY

The present disclosure is directed to sewage and storm water flow systems and methods, which use generator and small turbine assemblies positioned within one or more conduits (e.g. sewage or storm water conduits). One such system is a sewage or storm water flow power generation system comprising a generator, at least one electrical connector coupled to the generator, and a small turbine coupled to the generator. The turbine includes a shaft mountable to a lower conduit base and at least one anchor coupled to the shaft, which is mountable to a conduit wall. In a preferred arrangement, the turbine, generator, and shaft are oriented along the same vertical axis. The turbine can also include a plurality of hydrofoil blades, which are oriented in a substantially vertical position. Each turbine blade is coupled to a support arm, which is also coupled to the shaft.

Another system for sewage flow power generation comprises an array of turbine and generator assemblies positioned in a sequential arrangement along a conduit. The sequential arrangement may include arranging the assemblies in an alternating offset pattern along a length of the conduit. Each turbine and generator assembly includes a generator, a turbine coupled to the generator and positioned within a conduit, and at least one anchor coupled to the shaft and mounted to an upper conduit section. Turbines included within the assembly can each have a shaft mounted to a lower conduit base. A plurality of electrical connectors may also be coupled to each assembly for transmitting energy output from each assembly to an electrical grid, for example.

This type of power generation system may be located in a sewage system or a storm water discharge system. Where the power generation system is located in a sewage system, the system preferably has an average minimum liquid sewage depth, which is not less than about 3 feet. Alternatively or in addition, the sequential array may be arranged in a sewage conduit of a sewage system located at one or both of within about 1000 feet downstream of a sewage treatment facility or within 1000 feet upstream of the sewage treatment facility (i.e. after treatment to a purer, but still non-potable state). A typical sewage treatment plant (e.g. Tillman, Van Nuys, Calif.) has multiple channels, which flow into the plant, offering multiple locations for insertion of turbines for compounding energy production at processing sites.

Also disclosed herein is a sewage flow power generation method, which includes the steps of maintaining an array of turbine and generator assemblies located in a sewage conduit; contacting the array with sewage flowing through the sewage conduit; and generating electricity through use of the turbine and generator assemblies. Such methods may also include one or more steps for directing sewage flow from either a gravity-fed urban sewage system or gravity-fed storm water discharge system into the sewage or storm water conduit. The City and County of Los Angeles are examples of large areas, which utilize gravitational flow so that treatment plants are placed in low lying geographical areas, where less than approximately 5% of sewage movement is pump driven.

Electricity generated by the systems and methods disclosed herein may have several “green” applications. For example, the generated electricity may be used to purify water or to desalinate water to a potable state. In yet another method or system, the generated electricity may be used to manufacture hydrogen fuel from water. Although since the 1920's many patents have disclosed small water turbines, only a few are known to have mentioned small turbine use in sewage or storm water drains for energy generation. In addition, none of these patents are known to disclose specific applications of energy generation for “green” technologies or the use of a treatment plant as an onsite source of power production, as further described herein.

A more complete understanding of the sewage and/or storm water flow systems and methods disclosed herein will be afforded to those skilled in the art, as well as a realization of additional advantages and objects thereof, by consideration of the following detailed description. Reference will be made to the appended sheets of drawings which will first be described briefly.

### BRIEF DESCRIPTION OF THE DRAWINGS

The drawings described herein are for illustrative purposes and are not intended to limit the scope of the present disclosure. Like element numerals may be used to indicate like elements appearing in one or more of the figures.

FIG. 1 is a perspective view of a sewage or storm water flow system, including a plurality of turbine and generator assemblies in a sewage and/or storm water conduit.

FIG. 2 is a front view of a small turbine for use in the system shown in FIG. 1.

FIG. 3 is a top view of an array for use in a sewage and/or storm water flow system.

FIG. 4 is a top view of an array, coupled to a narrowing component for acceleration of sewage and/or storm water flow rates.

FIG. 5 schematically shows an exemplary power generation and consumption system.

FIG. 6 is a flowchart, showing a method of sewage flow power generation.

FIG. 7 is a lower aerial view of multiple conduits, each containing turbines, that lead into a sewage processing plant, with connections for distributing energy to an onsite structure consuming power for one or more “green” applications.

### DETAILED DESCRIPTION

The present disclosure relates to a source of continuous hydrodynamic energy that can have minimal impact on the environment and significantly lower implementation costs for power generation. Large cities virtually can have thousands of miles of rivers flowing under streets and sidewalks, bearing wastewater and watershed runoffs from garden and surface areas. Currently, these rivers add a cost burden to municipalities. The present disclosure explains how these rivers can serve as a source of substantial, continuous, non-polluting hydrodynamic energy, which may be exploited by cities for revenue and cost reduction.

Sewage flow may therefore be an untapped source of continuous hydrodynamic energy. Wind and sunshine may wane, but sewage flow, particularly in urban areas, remains relatively constant. In some major cities, for example, between 700 and 900 million gallons of sewage flows continuously through sewage lines each day. Harnessing hydrodynamic energy from continuous sewage flow, however, may present significant challenges. The following facts illustrate the potential of harnessing energy from sewage flow in just one metropolitan area:
The County of Los Angeles County currently operates eleven sewage water reclamation plants.
The City of Los Angeles' Department of Sanitation currently operates four sewage water reclamation plants in collaboration with the Department of Water & Power. These plants are named Tillman, Hyperion, Glendale, and Terminal Island.
In 2006, Tillman, Hyperion, Glendale, and Terminal Island each respectively yielded approximate sewage flow rates of 50, 323, 17, and 16 million gallons/day.
Daily power usage for a large city (e.g. Los Angeles) is about 5000 megawatts.
Estimated combined sewage flows in the City of Los Angeles and the County of Los Angeles is approximately 800 million gallons/day. A sewage flow power generation system could generate a significant amount of energy, depending upon the number of turbine arrays installed.
In the City and County of Los Angeles, over 95% of sewage flow is gravitational, and not propelled by pumps because the water reclamation plants are placed at lower elevations than surrounding residences and buildings.
Main collection line sections of sewage lines in Los Angeles City and County have diameters ranging from 81 to 96 inches, which would allow a person to fit within a main line for servicing. Major interceptor lines may be large, for example, such lines at Hyperion may be up to 10 feet in diameter.
In order to process water to a non-potable state required for discharge, Tillman's expenses are approximately $105 million/year. Based on this value, estimated costs for other plants in may be on the order of $1 billion/year in Los Angeles City and County.
Los Angeles City and County can also have non-sewage (storm runoff) systems which flow millions of gallons of runoff water into the ocean when precipitation falls.

Considering this information, one prior proposal indicates a method for harnessing hydrodynamic energy from sewage flow includes using turbines positioned above sewage flow. According to this method, turbines are encased at least partially within housings located at intervals along sewage lines and pipelines. In the proposed arrangement, each turbine is coupled to a generator located outside of each housing. Unfortunately, significant excavation and modification to existing sewage lines and pipelines may be required, which may render this proposed method both impractical and cost prohibitive.

Another previously proposed method for harnessing hydrodynamic energy from sewage flow describes a computerized system positioned near an outflow end of a wastewater pipe. The computerized system attaches at the outflow end and uses a flapper controlled by a computer to monitor outflow. This type of system, however, is described as an add-on to the outflow end of existing wastewater lines. The complete installation may require a computer control room and an electrical cable control room at the outflow end of wastewater pipes. Thus, implementing this system may require significant construction and modification to existing wastewater lines, also making this proposed method both impractical and cost prohibitive.

These proposed methods have also not fully considered the application of the power generated after energy from sewage flow has been harnessed. As non-renewable energy sources are depleted, the need for new applications and development of “green” technologies, utilizing energy harnessed from sewage flow becomes clearer. New “green” technologies, as described herein, may be implemented by generation of power at major collection sites where sewage and storm drain runoffs are processed, for example.

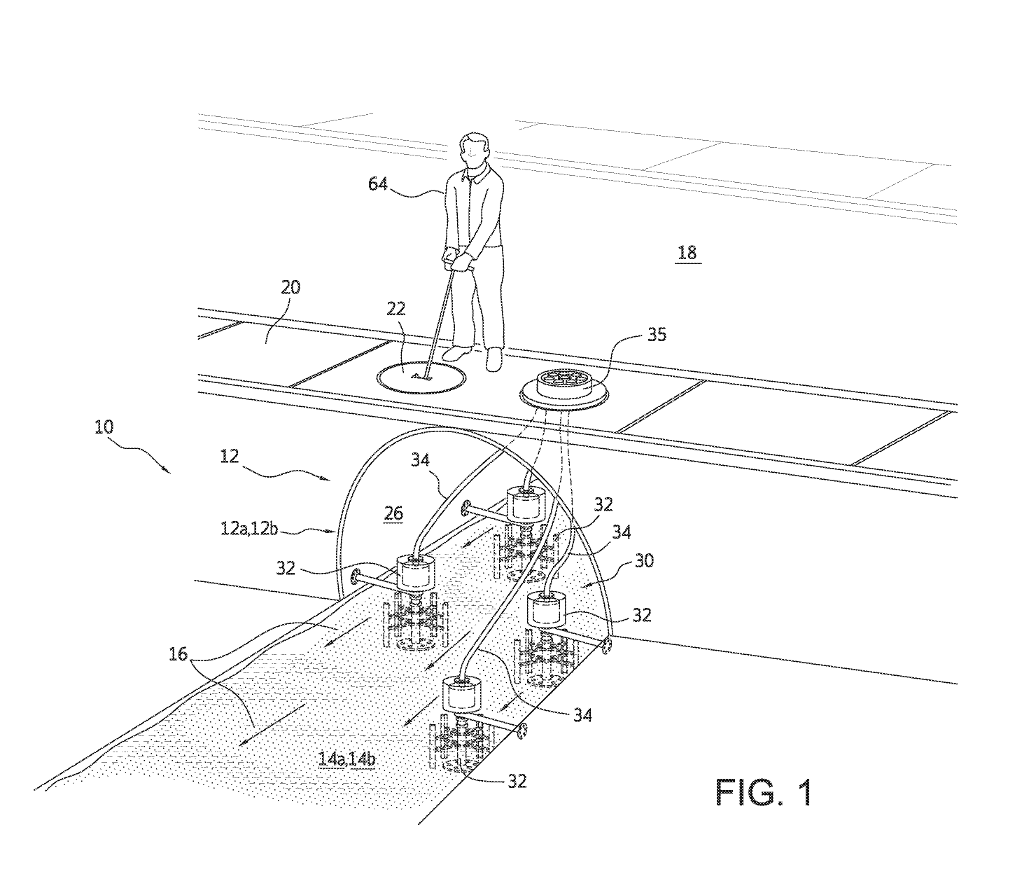

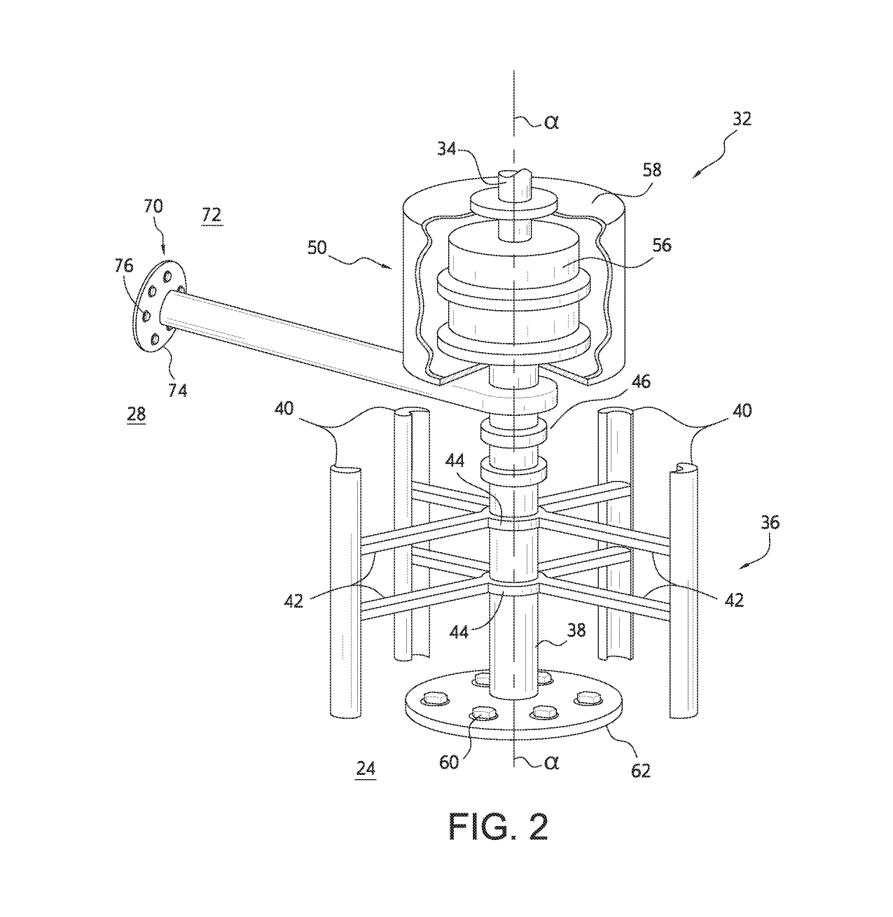

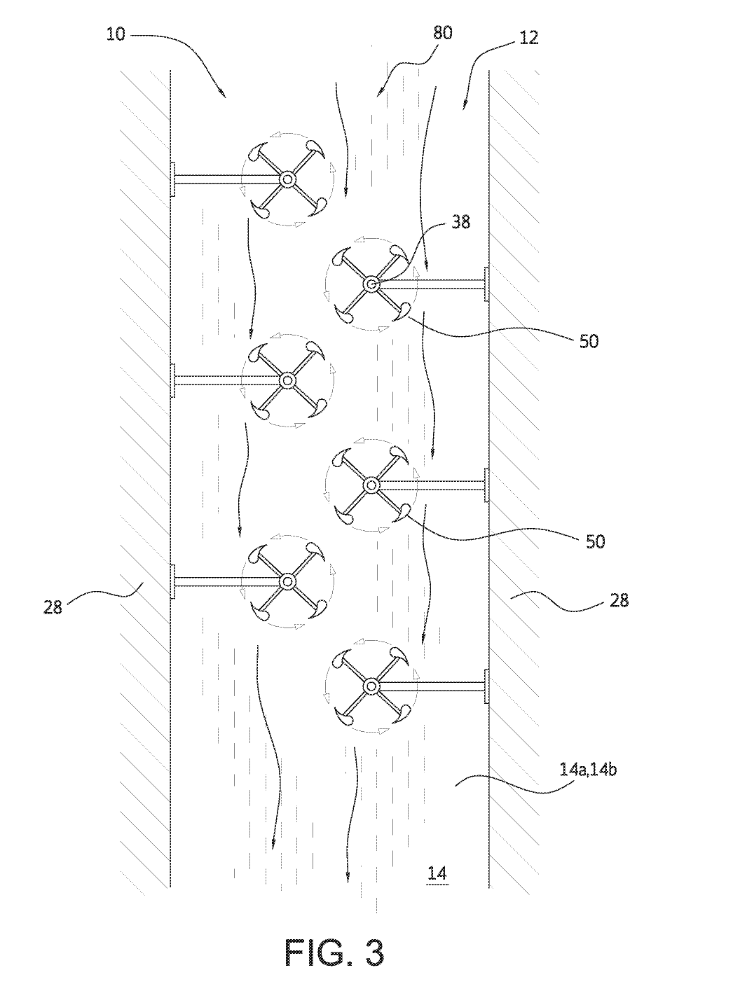

Turning in detail to the drawings, FIG. 1 shows a sewage and/or storm water flow system 10 positioned within a conduit 12, such as a sewage conduit 12a or storm water conduit 12b, containing sewage flow 14a and/or storm water flow 14b. As used herein, sewage flow is generally defined as water, containing particulates that originate from waste water drainage systems positioned at least partially underground. Similarly, storm water flow, as used herein, is generally defined as water, which originates from storm water drainage systems positioned at least partially underground. Storm water flow 14b can therefore include, but is not limited to flow emanating from lawns, gutters, and drainage systems for industrial facilities. Arrows 16 generally indicate the direction of the flow 14a, 14b in the conduit 12. Conduits of this type may be typically positioned underground, i.e. underneath streets 18 and sidewalks 20 in urban areas, which include points of access 22 to conduits 12. Access for servicing may also be gained through an open end of the conduit 12, after flow has been temporarily blocked or shunted away. These types of conduits can include a lower conduit section 24, e.g. a bottom or conduit base (FIG. 2) positioned under sewage or storm water flow, an upper conduit section 26 (FIG. 1) positioned above sewage or storm water flow, and sidewalls 28 (FIG. 3).

The system 10 may include a plurality 30 of turbine and generator assembles 32, with each assembly being coupled to one or more electrical connectors 34, which integrate into a collection of cables contained in a housing 35. These connectors may include cables or wiring used to link with an electrical grid, which can provide power to local and distant recipients, for example. The housing 35 may be positioned above ground for coupling with the electrical grid. To avoid line loss, however, onsite energy conveyance is one aspect of a preferred system embodiment.

Referring to FIG. 2, each turbine and generator assembly 32 includes a turbine 36, having a shaft 38, which acts as a rotor, and turbine blades 40. The turbine blades 40 are coupled to the shaft 38 via support arms 42, using shaft couplers 44. One or more support arms 42, which are coupled to shaft couplers 44, are connected to turbine blades 40, as shown in FIGS. 1 and 2. The shaft couplers 44 act as a hub for rotation of the blades around shaft 38. One or more bearings 46 may also be coupled to the shaft 38.

Hydrofoils 48, which are aerodynamically shaped, may be used as turbine blades 40. Hydrofoil blades are less likely to trap particles flowing through sewage flow. In one configuration a plurality of turbine blades 40 are oriented to a substantially vertical axis a and positioned in a symmetrical arrangement with respect to the vertical axis a to spin 360 degrees around the shaft 38.

In one blade arrangement, four turbine blades are positioned in about 90 degree increments with respect to the vertical axis, as shown in FIG. 3. Blade arrangements may include four to six blades positioned symmetrically with respect to axis a. However, various blade arrangements may be suitable, depending on the size and shape of turbine blades. Blade types and arrangements shown herein are not to be construed as limiting. Alternative blade arrangements include those used in Davis-type turbines, Gorlov-type turbines, modified Davis-type and Gorlov-type turbines, and other types of turbines designed for underwater applications in lower flow systems.

The turbine 36 and its respective components are used to convert power from sewage and/or storm water flow 14 into mechanical power via the shaft 38. The turbine may be configured to have an overall height ranging from about three feet to about five feet, depending upon conduit depth and anticipated flow heights. Therefore, the turbines specified herein are small, meaning each turbine has an overall height of less than about four feet. The height of the turbine, however, should be high enough for complete or at least partial submersion of turbine blades when flow is initiated within a conduit.

All turbine components are preferably manufactured from one or more materials, which are substantially resistant to chemicals likely present in sewage flow 14a and/or storm water flow 14b. In each turbine and generator assembly 32, torque from the shaft 38 is transmitted to a generator 50 or another type of power transfer device. In one configuration, the generator may include one or more electrical components 54 (not shown) and a gearbox 56 for converting rotation from the shaft to a higher rotation suitable for generating electricity. Various types of gearboxes may be included within the assembly 32.

The generator 50 may be encased within a housing 58, which is substantially impervious to water, sewage, weather and environmental moisture. FIG. 2 shows a break away view of generator components encased within the housing 58. The housing may be manufactured from one or more materials, which are substantially resistant to corrosion and degradation, resulting from frequent contact with sewage and/or storm water flow. Coupled to the gearbox 56 are one or more electrical connectors 34, which are used to transmit energy from the generator 50 to an electrical grid configured to provide power to local and distant recipients.

In one arrangement of a turbine and generator assembly 32, the shaft 38 is coupled to the lower conduit section 24, using bolts 60 or alternative fastener types, which are coupled to an assembly base 62. In an alternative arrangement of a turbine and generator assembly (not shown), the shaft 38 may extend through to a generator positioned above a street 18 and/or sidewalk 20 (FIG. 1) above the conduit 12. This type of arrangement may also prevent complete or partial submersion of the generator, particularly during levels of high sewage and/or storm water flow.

Turbine and generator assemblies 32 may also include at least one anchor 70 coupled to the shaft 38 and to at least one wall section 72 of the conduit 12. For example, an anchor 70 may be coupled to a conduit sidewall 28, as shown in FIG. 2.

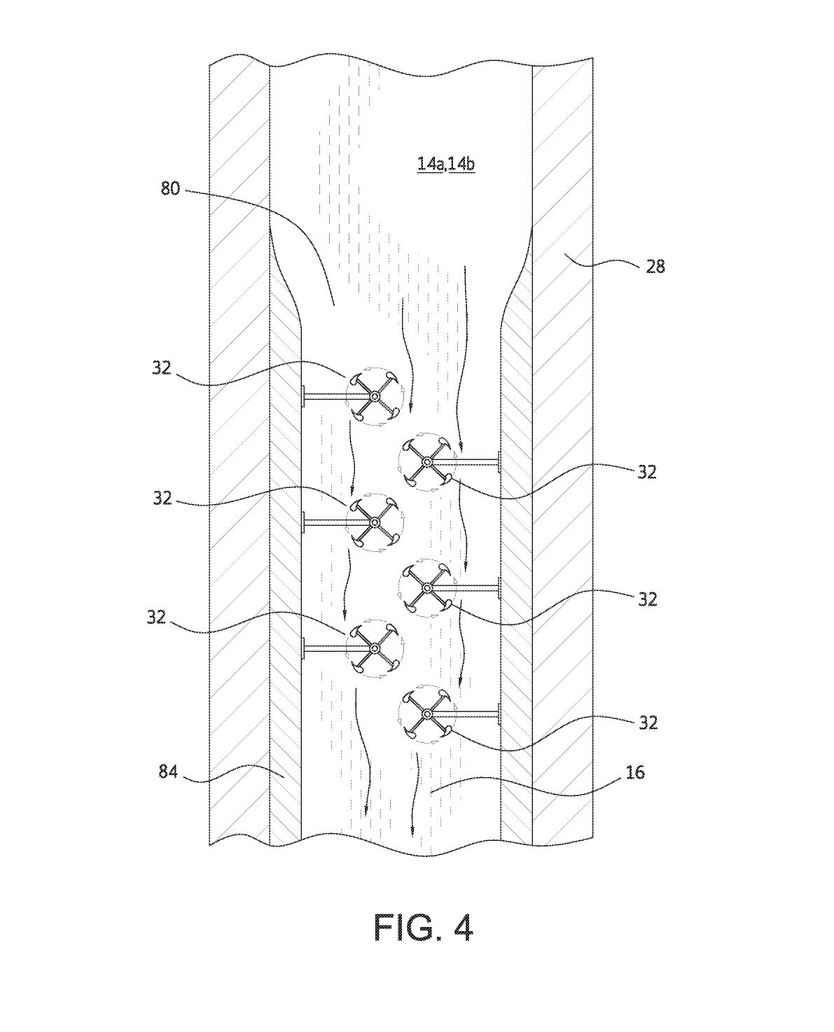

This type of arrangement may avoid interference with shaft rotation via an aperture in the end of the anchor distal from the wall section 72. The aperture in the anchor may be dimensioned with sufficient clearance for the shaft to freely rotate. The anchor 70 allows an assembly 32 to resist movement when subject to sewage and/or storm water flow. The anchor may include an anchor base 74 that is coupled to the wall section 72 or a narrowing component 84 (FIG. 4), using fasteners 76 such as bolts or screws. One or more bearings (not shown) may also be coupled to the anchor. All anchor components are preferably manufactured from one or more materials, which are substantially resistant to chemicals present in sewage flow and/or storm water flow. The materials may include, stainless steel, e.g. 316 stainless steel.

Flows in a sewage and/or storm water system 10 typically flow at lower flow rates. Incoming flows, for example, can range from about 5 feet per second to about 15 feet per second. As such, a turbine and generator assembly may be positioned at one or more inflow passages, i.e. a passage typically within about 50 to about 100 feet of a water treatment facility. Sewage and storm water flow rates at inflow passages are likely to be greater compared to outflow passages. Nonetheless, the system 10 may also be placed close to outflow passages, where outflow rates are sufficient. Narrowing components 84 (FIG. 4) may be required to accelerate flow in inflow and outflow passages. Sewage and storm water flow at inflow passages are also known to have a greater percentage of liquid (typically over 90%), which further lessens the chance of solid particles being captured by turbine blades 40.

In addition, the system 10 is preferably located in a conduit, having an average minimum liquid sewage depth not less than about 3 feet. Alternatively or in addition, an array 80 may be arranged in a sewage conduit of a sewage system located at one or both of within about 1000 feet downstream of a sewage treatment facility or within 1000 upstream of the sewage treatment facility.

Turbine and generator assemblies 32 may be uncoupled to computer systems, flapper gates, or valves required for flow regulation. Each turbine used in an assembly is configured such that its rate of rotation may vary, depending on incident variations of sewage and/or storm water flow in the system. In some assembly arrangements, however, flow meters may be utilized to monitor energy produced by the assembly 32 or the plurality 30 of turbine and generator assemblies.

In a preferred arrangement, a turbine and generator assembly may also be positioned close to one or more points of access 22 so that one or more maintenance workers 64 (FIG. 1) may maintain, repair, and/or replace the assembly when and if necessary.

The plurality 30 of turbine and generator assemblies 32 may be maintained in an array 80 such as a sequential array within the conduit 12, as shown in FIG. 3. The array shown in FIG. 3 is an offset or “zig-zag” array, which can provide adequate space for maintenance, repair, and replacement of assembly components. For example, during maintenance periods repair personnel may perform periodic, routine cleaning and servicing. The array is preferably positioned within the conduit such that personnel may access the array via the point of access 22 located on a street or sidewalk, for example.

When and if necessary, conduits may be modified to narrow conduit width, thereby increasing velocity of sewage and/or storm water flow. Wider sewage conduits may be modified to add a structural material, (e.g. concrete), to wall areas 82 adjacent an array 80. In addition, as shown in FIG. 4, a narrowing component 84 may be included within a conduit to narrow a conduit section 86, containing the sequential array 80. Without these types of modifications, difficulties may be encountered which limit conduit velocity to below operating ranges for many types of hydraulic turbines. Typically flow rates less than about 10 feet/second can cause slow rotation for some types of turbines. Therefore, to increase flow velocity, the conduit width or pipeline diameter may be constricted, especially for gravitational flows. Installation of a narrowing component 84, such as that shown in FIG. 4, may require minimal alteration to existing conduits. Narrowing components could, for example, be located adjacent a sequential array 80 such that flow rates where turbines are located are increased to sufficient levels.

Energy generated by turbine and generator assemblies is effectively renewable energy, which may be used to generate electricity for various types of “green” technologies. For example, generated electricity from the assemblies may be used for power consumption and include methods of water purification, water desalination, and production of hydrogen fuel. These “green” technologies, while greatly desirable, if previously proposed methods are used, have the potential to pull undesirable amounts of electricity from a community grid. As such, the flow systems 10 described herein can be utilized in a power plant, which would self-support system maintenance and repair and provide revenue for communities in surrounding areas.

Earth is about seventy-two percent (72%) water. But, only about two-percent (2%) of water on Earth is suitable for human consumption. And, most of this two-percent is primarily used for non-drinking purposes. Purification and desalination are just two of the viable uses for energy generated from the systems described herein.

Purification of sewage and storm water flow requires power which in many cases is derived from an already-stressed community grid. The energy intensity for reclamation and re-use of non-potable water can be 1.84 kilowatt-hours per kilo-gallon (kWh/kgal) at a cost of $0.46/kgal for at least one major city in the United States as of 2011. Desalination of sewage and storm water flow is also a process which demands significant power. For desalination, energy cost is 12 kWh/kgal or $3.10/kgal in at least one major city in the United States as of 2011. (See, “Water Re-Use Potential,” National Research Council, National Academy Press, 2011).

Many cities include up to six watersheds that empty into the ocean, providing water which could be used for desalination. Therefore, utilizing the electrical energy from this type of water flow could provide the additional energy necessary for providing potable water or hydrogen fuel without extracting energy from existing electrical grids. Line loss could also be prevented by providing onsite production of electrical energy, especially for desalination at ocean discharge sites.

Electrical energy generated from the systems and assemblies described herein may also be utilized to manufacture hydrogen fuel from water. High costs associated with manufacture of hydrogen fuel are typically cost prohibitive. At least one source indicates that producing hydrogen fuel from water or other compounds consumes more energy compared to the energy recovered when the hydrogen fuel is burned. In addition, approximately 3.58 gallons of liquid hydrogen fuel provide the same energy contained in approximately one gallon of gasoline. As of 2012, hydrogen fuel derived from water may cost up to $8.00 (US$) per gallon, or almost $30 (US$) to yield the same miles per gallon (mpg) as gasoline. Even if hydrogen fuels were derived from steam-injected methane hydrogen, costs to produce the hydrogen fuel may only be slightly less and still require electrical energy. According to one scenario, electricity produced at a selected wastewater processing plants could potentially lower the cost of hydrogen fuel production. This could revitalize use of hydrogen fuel. High costs typically associated with manufacture of hydrogen fuel could be offset by using the sewage and/or storm water flow systems and turbine and generator assemblies, and arrays described herein. Eventual development of a prototype may provide proof of concept for evolving these “green” systems from uneconomical technologies to useful and important assets.

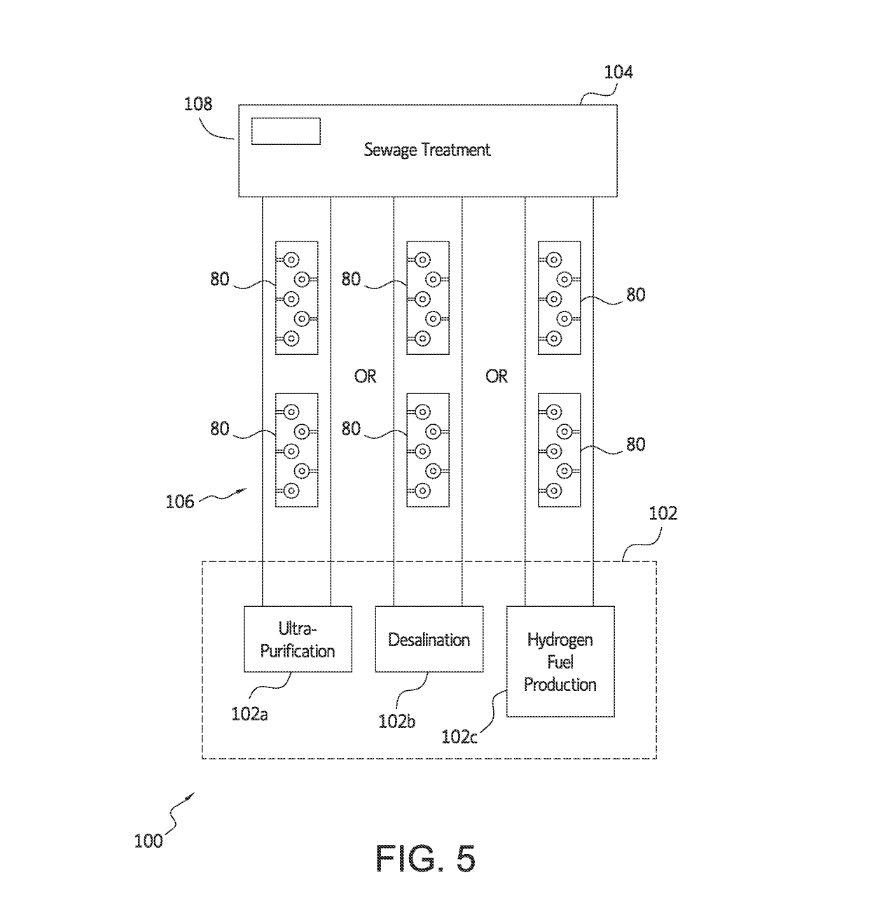

FIG. 5 schematically shows one exemplary power generation and consumption system 100, including one or more power consumption systems 102 (also called “synthesis plants”) that implement various types of “green” technologies, utilizing energy harnessed from the systems and assemblies described herein. For example, a power consumption system 102 may be a treatment plant for purification 102a and/or desalination 102b of water or a production facility 102c for hydrogen fuel. A treatment plant for desalination may, for example, be situated where treated sewage or storm water empties into saltwater bodies (e.g. coastal areas). The system 100 can further include the sewage treatment plant 104, which is the source of sewage and/or storm water flow, a plurality of sewer lines or conduits 106, and one or more arrays 80. Included within the treatment plant 104 may be one or more waste water processing centers 108, which may be used, in part, to consume electricity generated to process the sewage within the system 100 itself, replacing power that would otherwise be drawn from other sources powering the general community grid.

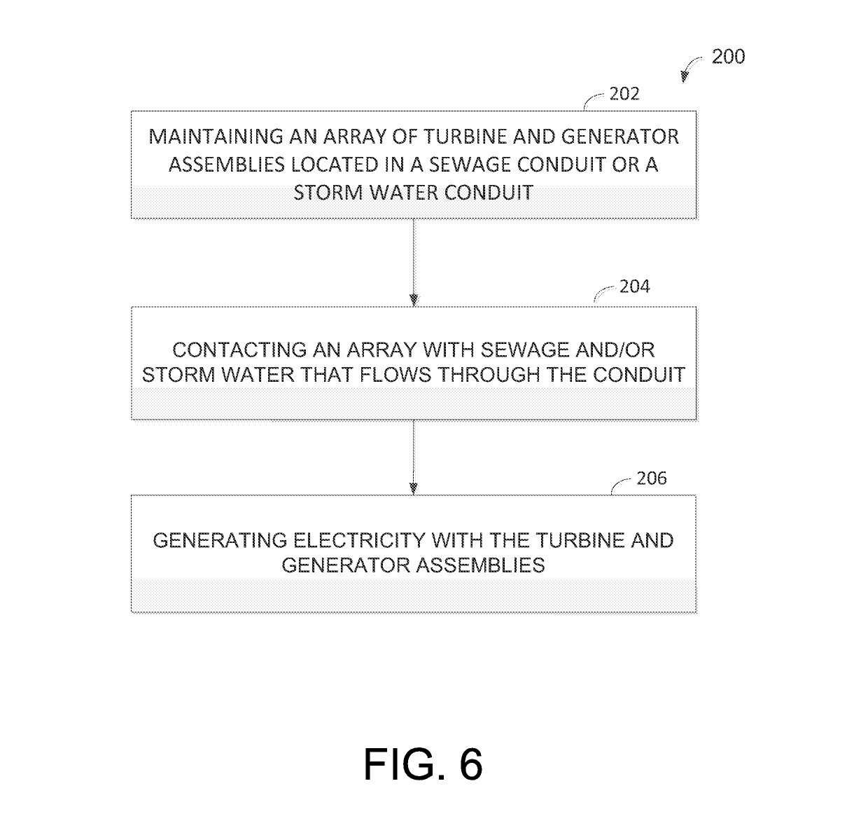

As shown in FIG. 6, a method for sewage flow and/or storm water flow power generation may include various steps for deriving energy from one or more turbines, turbine and generator assemblies, or at least one array of turbine and generator assemblies. One method of power generation 200 may include, at 202, maintaining an array of turbine and generator assemblies located in a sewage conduit or a storm water conduit. By maintaining the array, the method may also include at 204, contacting an array with sewage and/or storm water that flows through the conduit, and at 206, generating electricity with the turbine and generator assemblies. After electricity is generated, a processing center (synthesis plant) may consume the generated electricity. Additional method steps may include directing the sewage flow from a gravity-fed urban sewage system into the conduit or directing the sewage flow from a gravity-fed storm water discharge system into the sewage conduit. These methods may further include additional steps of, using the generated electricity to purify or ultrapurify water, desalinate water, and/or manufacture hydrogen fuel at the synthesis plant.

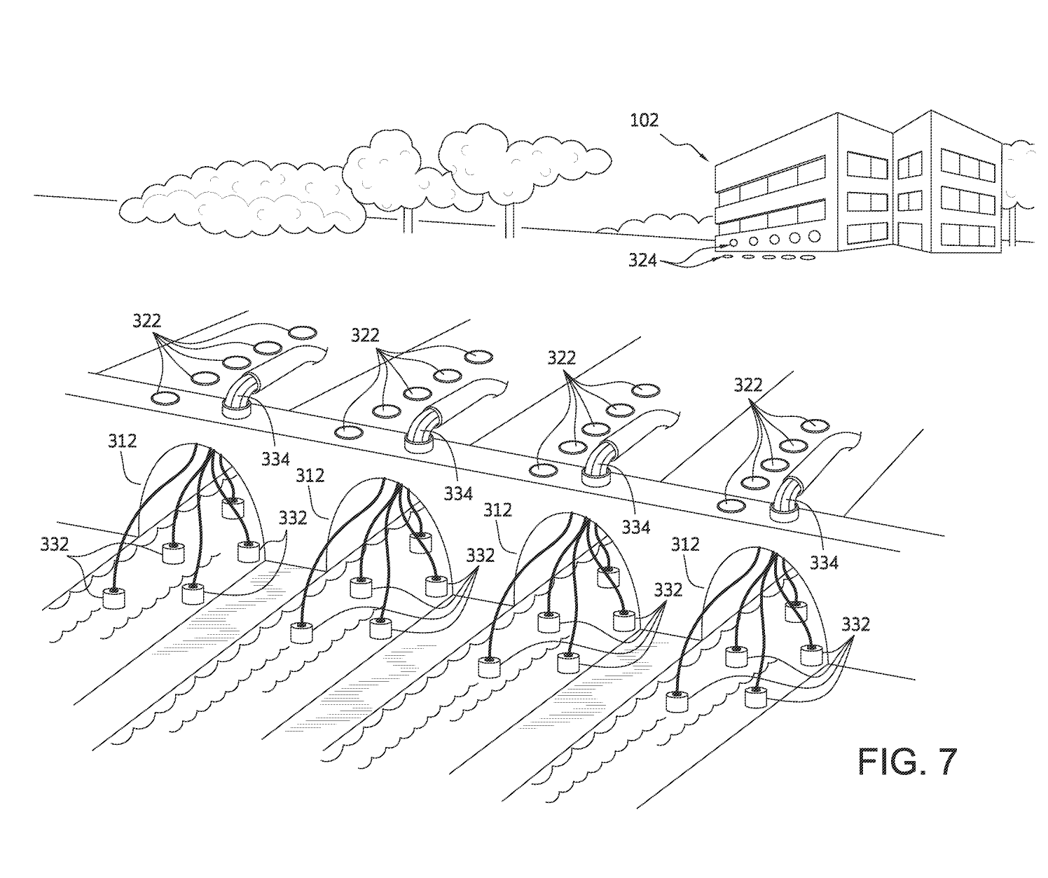

FIG. 7 shows a low aerial view of a system having multiple conduits 312 configured to enter into a power consumption system 102 such as, for example, a synthesis plant. Each conduit may contain an array of turbine/generator assemblies 332, which are coupled to electrical cables 334 for transmitting power to a power grid or other power consumption unit 102. The power consumption unit 102 may also include multiple ports 324 for entry and exit of the electrical cables 334. Multiple points of access 322 to the system may also be provided. When this type of system is in use, electrical power generated may be proportional to the number of conduits 312 and the number of turbine/generator assemblies within in each conduit 312, compounding the energy produced.

Accordingly, sewage flow power generation systems and methods, using generator and small turbine assemblies and arrays are disclosed. While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A sewage flow power generation system, comprising:
a generator;
at least one electrical connector coupled to the generator;
a turbine coupled to the generator, having a shaft mountable to a sewage conduit base; and
at least one anchor coupled to the shaft, the at least one anchor being mountable to a sewage conduit wall.

2. The system of claim 1, wherein the turbine is oriented to a substantially vertical axis.

3. The system of claim 1, wherein the turbine and the generator are oriented to a substantially vertical axis.

4. The system of claim 1, wherein the turbine, the generator, and the shaft are aligned along a substantially vertical axis.

5. The system of claim 1, wherein the turbine comprises a plurality of blades oriented to a substantially vertical axis.

6. The system of claim 5, wherein each blade is coupled to a support arm.

7. The system of claim 6, wherein the support arm is coupled to the shaft.

8. The system of claim 1, wherein the at least one electrical connector is coupled to an electrical grid.

9. The system of claim 1, wherein the generator is contained within a housing that is substantially impervious to sewage.

10. The system of claim 1, wherein the shaft and the anchor each comprise stainless steel.

11. A sewage flow power generation system, comprising:
a sequential array of turbine and generator assemblies, wherein each assembly comprises:
a generator,
a turbine coupled to the generator and positioned within a sewage conduit, the turbine having a shaft mounted to a lower sewage conduit base; and
at least one anchor coupled to the shaft and mounted to an upper sewage conduit section; and
a plurality of electrical connectors coupled to each assembly.

12. The system of claim 11, wherein the sewage conduit is located in a storm water discharge system.

13. The system of claim 11, wherein the sequential array comprises the turbine and generator assemblies arranged in an alternating offset pattern along a length of the sewage conduit.

14. The system of claim 11, wherein the sequential array is located in a sewage conduit of a sewage system with an average minimum liquid sewage depth is not less than about 3 feet.

15. The system of claim 11, wherein the sequential array is in a sewage conduit of a sewage system located at one or both of within about 1000 feet upstream of a sewage treatment facility or within 1000 feet downstream of the sewage treatment facility.

16. A sewage flow power generation method, comprising:
maintaining an array of turbine and generator assemblies located in a sewage conduit;
contacting the array with sewage flowing through the sewage conduit; and
generating electricity with the turbine and generator assemblies.

17. The method of claim 16, further comprising directing the sewage flow from a gravity-fed urban sewage system into the sewage conduit.

18. The method of claim 16, further comprising directing the sewage flow from a gravity-fed storm water discharge system into the sewage conduit.

19. The method of claim 16, further comprising using the generated electricity to purify water to a potable state.

20. The method of claim 16, further comprising using the generated electricity to desalinate water.

21. The method of claim 16, further comprising using the generated electricity to manufacture hydrogen fuel from water.

22. The method of claim 16, wherein flow-generated power provides energy for treatment plant operations.
